(19) United States
(12) Patent Application Publication
(10) Pub. No.: US 2025/0273649 A1
(43) Pub. Date: Aug. 28, 2025

(54) APPARATUS AND METHOD FOR MANUFACTURING ELECTRODE SUBSTRATE OF SECONDARY BATTERY AND ELECTRODE SUBSTRATE MANUFACTURED BY THE METHOD

(71) Applicant: SAMSUNG SDI CO., LTD., Yongin-si (KR)

(72) Inventor: Hyunjin Lee, Yongin-si (KR)

(21) Appl. No.: 18/811,422

(22) Filed: Aug. 21, 2024

(30) Foreign Application Priority Data
Feb. 26, 2024 (KR) 10-2024-0027435

(51) Int. Cl. H01M 4/04; B21B 1/46; B22D 21/00; B22D 41/01; H01M 10/04

(52) U.S. Cl. CPC H01M 4/0485; B21B 1/463; B22D 21/007; B22D 41/01; H01M 4/0404; H01M 4/0433; H01M 4/0435; H01M 10/0404

(57) ABSTRACT

An apparatus for manufacturing an electrode substrate of a secondary battery may include a reinforcement body molding machine configured to mold a reinforcement body from a reinforcement material, a melting furnace configured to melt a substrate material and mix the molded reinforcement body in the melted substrate material for dispersion, a casting machine containing the reinforcement body configured to mold a slab with the melted substrate material produced by the melting furnace, and a rolling mill configured to form an electrode substrate by rolling the slab.

### CROSS-REFERENCE TO RELATED APPLICATION

The present application claims priority to and the benefit of Korean Patent Application No. 10-2024-0027435, filed on Feb. 26, 2024, in the Korean Intellectual Property Office, the entire disclosure of which is incorporated herein by reference.

### BACKGROUND

### 1. Field

Aspects of some embodiments of the present disclosure relate to a secondary battery, and more particularly, to an apparatus and a method for manufacturing a substrate for electrode plate manufacturing, and an electrode substrate manufactured by the same.

### 2. Description of Related Art

Unlike primary batteries that are not designed to be charged, secondary batteries are designed to be discharged and recharged. In general, a secondary battery includes an electrode assembly composed of positive/negative electrode plates and a separator. The positive/negative electrode plates of the electrode assembly may be manufactured through processes such as rolling, drying, slitting, and notching subsequent to a process of coating an active material on a substrate.

The active material coating process for manufacturing the negative electrode plate may include coating an active material such as graphite or carbon on a substrate made of metal such as cooper, cooper alloy, nickel, or nickel alloy, and the active material coating process for manufacturing the positive electrode plate may include coating an active material such as a transition metal oxide on a substrate made of a metal such as aluminum or aluminum alloy.

Recently, the thickness of an electrode substrate has become thinner in order to secure a battery capacity, and the current minimum thickness of the substrate is about 4 μm to about 8 μm. Breakage or damage may occur from physical impact that is applied to a substrate during coating, rolling, slotting, notching, and/or the like, during the manufacturing of an electrode plate utilizing such thin substrate, and if (e.g., when) a substrate is broken, productivity may be reduced because time and manpower is required for connecting the broken substrate.

The above information disclosed in this Background section is for enhancement of understanding of the background of the present disclosure, and therefore, it may contain information that does not constitute related (or prior) art.

### SUMMARY

Accordingly, an aspect of one or more embodiments of the present disclosure relates to an apparatus and a method for manufacturing an electrode substrate that reinforce the strength of a substrate by adding a reinforcement body that is stronger than a substrate material when the substrate is manufactured, and an electrode substrate manufactured by the same.

According to one or more embodiments of the present disclosure, an apparatus for manufacturing an electrode substrate of a secondary battery may include: a reinforcement body molding machine configured to mold a reinforcement body from a reinforcement material; a melting furnace configured to melt a substrate material and mix the molded reinforcement body in the melted substrate material for dispersion; a casting machine containing the reinforcement body configured to mold a slab with the melted substrate material produced by the melting furnace; and a rolling mill configured to form an electrode substrate by rolling the slab.

The reinforcement material inputted into the reinforcement body molding machine may include a conductive material with greater strength than the substrate material.

The reinforcement material may be one or more materials selected from: tungsten carbide, a carbide-based metal, cobalt, titanium, nickel, iron, carbon steel, alloy steel, heat-treated steel, or carbon fiber.

A shape of the reinforcement body molded by the reinforcement body molding machine may be one or more shapes selected from: a plate shape, a needle shape, a fiber shape, or a linear shape.

The melting furnace may include: a substrate material input unit; a reinforcement body input unit configured to input the reinforcement body molded by the reinforcement body molding machine; a heating unit configured to generate heat for melting the input substrate material; and a stirring unit configured to mix the reinforcement body molded by the reinforcement body molding machine in the melted substrate material for dispersion.

The melting furnace may be further configured to melt the substrate material by heating the substrate material and the molded reinforcement body at a first temperature, and the first temperature is set to a temperature at which the substrate material melts and the molded reinforcement body does not melt.

The melting furnace may be further configured to melt the substrate material at a first temperature, and receive the molded reinforcement body responsive to the first temperature being adjusted to a second temperature, the first temperature is set to a temperature at which the substrate material melts and the molded reinforcement body does not melted, and the second temperature is set to a temperature lower than the first temperature.

The apparatus may further include: a surface coater configured to coat a metal layer on a surface of the formed electrode substrate.

In one or more embodiments, a method for manufacturing an electrode substrate of a secondary battery may include: molding a reinforcement body from a reinforcement material; melting a substrate material and mixing the molded reinforcement body in the melted substrate material for dispersion; molding a slab with the melted substrate material including the molded reinforcement body; and forming an electrode substrate by rolling the slab.

The reinforcement material for molding the reinforcement body may include a conductive material having a greater strength than the substrate material.

The reinforcement material may include one or more materials selected from: tungsten carbide, a carbide-based metal, cobalt, titanium, nickel, iron, carbon steel, alloy steel, heat-treated steel, or carbon fiber.

A shape of the reinforcement body molded in the molding the reinforcement body may include one or more shapes selected from: a plate shape, a needle shape, a fiber shape, or a linear shape.

The melting the substrate material and mixing the molded reinforcement body in the melted substrate material for dispersion may include: melting the substrate material by heating the substrate material and the molded reinforcement body at a first temperature, and wherein the first temperature is set to a temperature at which the substrate material melts and the molded reinforcement body does not melt.

The melting the substrate material and mixing the molded reinforcement body in the melted substrate material for dispersion may include: melting the substrate material at a first temperature, adjusting the first temperature to a second temperature, and receiving the molded reinforcement body after adjusting the first temperature, wherein the first temperature is set to a temperature at which the substrate material melts and the molded reinforcement body does not melt, and the second temperature is lower than the first temperature.

The method may further include coating a metal layer at a surface of the formed electrode substrate.

In one or more embodiments, an electrode substrate of a secondary battery manufactured by a method for manufacturing a secondary battery electrode substrate may include: molding a reinforcement body from a reinforcement material; melting a substrate material and mixing the molded reinforcement body in the melted substrate material for dispersion; molding a slab using the melted substrate material containing the molded reinforcement body; and forming a substrate by rolling the slab.

The reinforcement material may include a conductive material with greater strength than the substrate material.

The reinforcement material may include one or more materials selected from: tungsten carbide, a carbide-based metal, cobalt, titanium, nickel, iron, carbon steel, alloy steel, heat-treated steel, or carbon fiber.

A shape of the reinforcement body molded may include one or more shapes selected from a plate shape, a needle shape, a fiber shape, or a linear shape.

The method may further include coating a metal layer at a surface of the formed substrate.

Aspects of the present disclosure is not limited to the above, and other aspects not specifically mentioned herein, and aspects of the present disclosure that would address such problems, will be clearly understood by those skilled in the art from the description of the present disclosure.

### BRIEF DESCRIPTION OF THE DRAWINGS

The following drawings attached to the present specification illustrate various embodiments of the present disclosure, and further describe aspects and features of one or more embodiments of the present disclosure together with the detailed description of the one or more embodiments of the present disclosure. Thus, the present disclosure should not be construed as being limited to the drawings:

FIG. 1 is a schematic view of an electrode assembly of a secondary battery adopting the electrode substrates manufactured by the method according to one or more embodiments of the present disclosure;

FIG. 2 is a schematic configuration diagram of an electrode substrate manufacturing apparatus according to some embodiments of the present disclosure;

FIG. 3 is a schematic view illustrating a configuration of a reinforcement body molding machine 100, according to some embodiments of the present disclosure;

FIG. 4 is a schematic view illustrating an example configuration of a melting furnace 110, according to some embodiments of the present disclosure;

FIG. 5 is a perspective view of a substrate containing a reinforcement body manufactured by a substrate manufacturing apparatus and method according to some embodiments of the present disclosure;

FIG. 6 is a schematic configuration diagram of some other embodiments of an electrode substrate manufacturing apparatus of one or more embodiments of the present disclosure;

FIG. 7 is a schematic view illustrating a schematic configuration of a mixing furnace in FIG. 6, according to one or more embodiments of the present disclosure;

FIG. 8 is a schematic configuration diagram of some other embodiments of an electrode substrate manufacturing apparatus of one or more embodiments of the present disclosure;

FIG. 9 is a cross sectional view of a metal substrate on which a first side metal layer and a second side metal layer are additionally formed by a surface coater, according to one or more embodiments of the present disclosure;

FIG. 10 is a schematic view of a pouch-type secondary battery adopting the electrode substrates manufactured by the method of one or more embodiments of the present disclosure;

FIG. 11 is a cross-sectional view of a cylindrical secondary battery adopting the electrode substrates manufactured by the method of one or more embodiments of the present disclosure;

FIG. 12 illustrates an internal configuration of a prismatic secondary battery adopting the electrode substrates manufactured by the method of one or more embodiments of the present disclosure;

FIG. 13 is a view of a secondary battery module in which the secondary batteries are arranged according to one or more embodiments of the present disclosure;

FIG. 14 is a view of a secondary battery pack including the secondary battery module illustrated in FIG. 13, according to one or more embodiments of the present disclosure; and

FIG. 15 is a perspective view of a vehicle including the secondary battery pack illustrated in FIG. 14, according to one or more embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

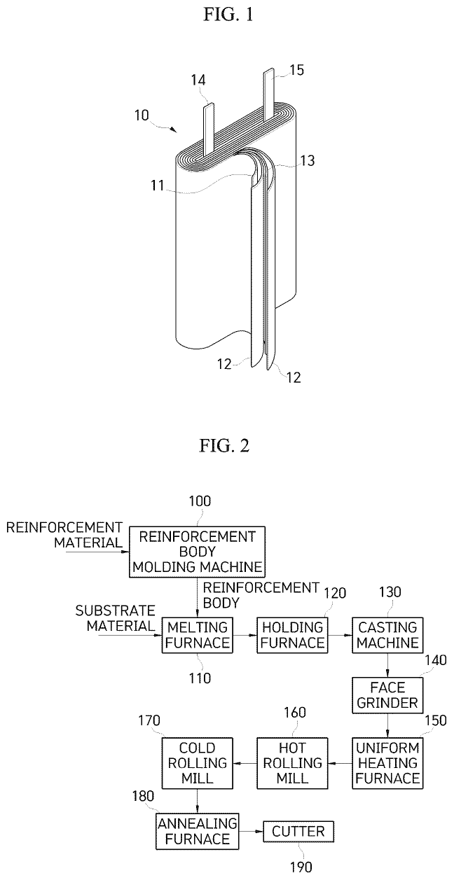

FIG. 1 shows an electrode assembly of a secondary battery.

An electrode assembly 10 may be formed by winding or stacking a stack of a first electrode plate 11, a separator 12, and a second electrode plate 13, which are formed as thin plates or films. In other embodiments, the electrode assembly 10 may be a stack type rather than a winding type (or wound type), and the shape of the electrode assembly 10 is not limited to that shown or described in the present disclosure. In one or more embodiments, the electrode assembly 10 may be a Z-stack electrode assembly in which a positive electrode plate and a negative electrode plate are inserted into both sides of a separator, which is then bent into a Z-stack (e.g., a stack that has a shape of a Z). In one or more embodiments, one or more electrode assemblies may be stacked such that long sides of the electrode assemblies are adjacent to each other and accommodated in the case, and the number of electrode assemblies in the case is not limited to that shown or described in the present disclosure. The first electrode plate 11 of the electrode assembly may act as a negative electrode, and the second electrode plate 13 may act as a positive electrode, or vice versa.

The first electrode plate 11 may be formed by applying a first electrode active material, such as graphite or carbon, to a first electrode current collector formed of a metal foil, such as copper, a copper alloy, nickel, or a nickel alloy. The first electrode tab 14 may be connected to an external first terminal. In some embodiments, when the first electrode plate 11 is manufactured, the first electrode tab 14 may be formed or cut such that it protrudes from one side of the electrode assembly 10. The first electrode tab 14 may protrude from one side of the electrode assembly 10 more than (e.g., farther than or beyond) the separator 12.

The second electrode plate 13 may be formed by applying a second electrode active material, such as a transition metal oxide, on a second electrode current collector formed of a metal foil, such as aluminum or an aluminum alloy. The second electrode plate 13 may include a second electrode tab 15 (e.g., a second uncoated portion) to which the second electrode active material is not applied. The second electrode tab 15 may be connected to an external second terminal. In some embodiments, the second electrode tab 15 may be formed or cut such that it protrudes from the other side (e.g., the opposite side) of the electrode assembly 10 when the second electrode plate 13 is manufactured. The second electrode plate 13 may protrude from the other side of the electrode assembly more than (e.g., farther than or beyond) the separator 12.

In some embodiments, the first electrode tab 14 may be located on the left side of the electrode assembly 10, and the second electrode tab 15 may be located on the right side of the electrode assembly 10. In other embodiments, the first electrode tab 14 and the second electrode tab 15 may be located on one side (e.g., the same side) of the electrode assembly 10.

Here, for convenience of description, the left and right sides are defined according to the electrode assembly 10 as oriented in FIG. 1, and the positions thereof may change if (e.g., when) the secondary battery is rotated left and right or up and down.

The separator 12 may prevent a short-circuit between the first electrode 11 and the second electrode 13 while allowing movement of lithium ions therebetween. The separator 12 may be made of, for example, a polyethylene film, a polypropylene film, a polyethylene-polypropylene film, and/or the like.

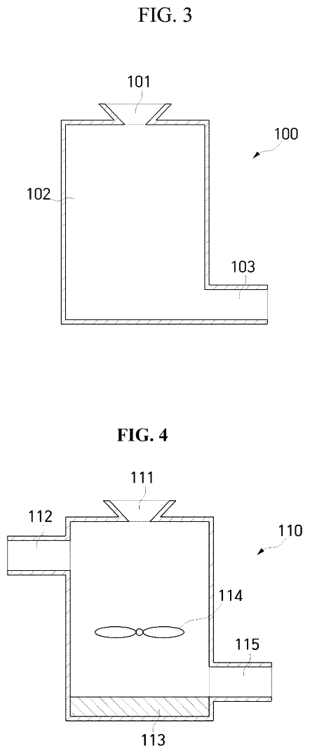

In some embodiments, the electrode assembly 10 may be accommodated in the case along with an electrolyte. In the case of a pouch-type secondary battery, an electrode assembly 10 may be accommodated in a pouch made of flexible material according to the steps described in the flow diagram shown in FIG. 2. In the case of a cylindrical or prismatic secondary battery, an electrode assembly 10 may be accommodated in a cylindrical or prismatic metal casing in the form illustrated in FIGS. 3 and 4.

In some embodiments, the first electrode plate 11 may be a negative electrode plate, and the first substrate may be a negative electrode substrate. The second electrode plate 13 may be a positive electrode plate, and the second substrate may be a positive electrode substrate. As the negative electrode substrate, a copper foil that is stable in an electrochemical reaction and has good or suitable electrical conductivity within an operating range of a carbon electrode may be utilized, and as the positive electrode substrate, an aluminum foil that is stable in an electrochemical reaction and good or suitable electrical conductivity even at higher potentials may be utilized.

The aluminum foil for the positive electrode substrate and the copper foil for the negative electrode substrate may be manufactured through a process of thinly and uniformly (substantially uniformly) spreading a raw material including aluminum or copper ingot with a rolling roller. In some embodiments, the copper foil may also be manufactured through an electrolytic plating process after dissolving a copper wire.

FIG. 2 is a schematic configuration diagram of an electrode substrate manufacturing apparatus according to some embodiments of the present disclosure.

The electrode substrate manufacturing apparatus according to some embodiments of the present disclosure may include: a reinforcement body molding machine 100 that molds a reinforcement body from an input reinforcement material; a melting furnace 110 that melts an input substrate material and mixes the molded reinforcement body in the melted substrate material for substantially uniform dispersion; a holding furnace 120 that performs degassing and component correction of the melted substrate material produced in the melting furnace 110 and containing the reinforcement body; a casting machine 130 that performs a cooling casting process of the substrate material produced in the holding furnace 120 and containing the reinforcement body and molds a slab having a rectangular parallelepiped or sheet shape; a face grinder 140 that grinds both sides of the slab in order to improve the surface quality of the slab and remove the reinforcement body exposed on the surface thereof; a uniform heating furnace 150 that relieves the internal stress of the slab subjected to the face cutting and softens a metal to improve rolling ease; a hot rolling mill 160 that rolls the slab produced in the uniform heating furnace 150 at a temperature of about 250° C. or higher; a cold rolling mill 170 that manufactures a substrate foil having a desired or suitable thickness by additionally rolling the primarily hot-rolled substrate semi-finished product at a temperature of less than about 250° C.; an annealing furnace 180 that reheats the rolled substrate foil at an appropriate or suitable temperature to facilitate reprocessing; and a cutter 190 that cuts the substrate foil manufactured through the annealing furnace 180 into pieces having a desired or required size.

Hereinafter, the each of the devices of the electrode substrate manufacturing apparatus in the above process will be described in more detail.

First, the substrate material input (e.g., inserted or placed) into the melting furnace 110 may include an aluminum ingot (e.g., for a positive electrode plate), a copper ingot (e.g., for a negative electrode plate), a hardener, a scrap (e.g., scrap materials), and/or the like.

In order to achieve the purpose of reinforcement, the reinforcement material inputted into the reinforcement body molding machine 100 may be a conductive material with greater strength than aluminum or copper, which are the main materials for a substrate. For example, the reinforcement material may be one or more materials including tungsten carbide, a carbide-based metal, cobalt, titanium, nickel, iron, carbon steel, alloy steel, heat-treated steel, and/or carbon fiber.

The shape of the reinforcement material inputted into the reinforcement body molding machine 100 may be arbitrary. However, when considering ease of molding and durability of the molding machine, the reinforcement material may be advantageous to have a spherical or granular shape with a diameter of several millimeters (mm), but the present disclosure is not limited thereto.

The reinforcement body molded by and produced in the reinforcement body molding machine 100 may have any shape as long as it is incorporated into the substrate to exhibit a reinforcement effect. For example, the shape of the reinforcement body may be a plate shape with a flat surface such as a polygon, a triangle, a square, a circle, or a needle shape such as a needle, a pin, or a thorn, a fiber shape such as a wool or a fiber, a linear shape such as a wire or a coil, various other suitable shapes and/or complex shapes thereof. A length of the molded reinforcement body may have a range of about 0.1 μm to about 100 μm, but the present disclosure is not limited thereto, and may depend on a thickness of the substrate, electrical conductivity, desired or required substrate strength conditions, and/or the like.

FIG. 3 is a schematic view illustrating the configuration of the reinforcement body molding machine 100.

An input unit 101 may be a hopper that inputs the reinforcement material into an internal space of the molding machine through a relatively narrow hole, but the present disclosure is not limited thereto. For example, if (e.g., when) the reinforcement material is solid, the input unit 101 may be configured in the form of a hopper, but if (e.g., when) the reinforcement material is liquid, the input unit 101 may be configured in the form of a tube.

A molding unit 102 may process or mold the shape of the input reinforcement material into a plate shape, a needle shape, a fiber shape, a linear shape, and/or the like, as described above. A mechanical or chemical micro-processing tool or laser (e.g., microwave laser, and/or the like) may be utilized for molding the reinforcement body. Because the molded reinforcement body is a fine (e.g., thin) structure (e.g., having a length of about 0.1 μm to about 100 μm) and is mixed in the melted substrate material, the molding unit 102 may utilize a tool that is capable of processing or molding such a fine structure.

A discharge unit 103 may discharge the molded reinforcement body. Although not specifically illustrated in FIG. 3, the discharge unit 103 may include a spiral body (e.g., auger, screw, and/or the like) that rotates to discharge the reinforcement body.

Returning back to FIG. 2, the melting furnace 110 may be configured to perform a function of melting the substrate material and a function of mixing the melted substrate material and the molded reinforcement body together.

FIG. 4 is a schematic view illustrating an example configuration of the melting furnace 110.

A substrate material input unit 111 may be a hopper that inputs the material for the substrate, such as an aluminum ingot (e.g., for a positive electrode plate), a copper ingot (e.g., for a negative electrode plate), a hardener, and/or scrap (e.g., scrap material), into the inner space of the melting furnace, but present disclosure is not limited thereto.

A reinforcement body input unit 112 is an inlet through which the molded reinforcement body molded by and discharged from the reinforcement body molding machine 100 is input, and is configured in the shape of an inlet as shown in FIG. 4, but the present disclosure is not limited thereto. For example, in some embodiments, the reinforcement body input unit 112 may be configured in the form of a hopper. The reinforcement body input unit 112 may be configured to be connected to the discharge unit 103 of the reinforcement body molding machine 100 so that the reinforcement body may continuously input into the melting furnace 110 from the reinforcement body molding machine 100.

A heating unit 113 may generate heat for melting the substrate material input into the melting furnace 110. The melting temperature of the substrate material depends on the type or kind and melting point of the substrate. The melting point of an aluminum substrate may be set to about 700° C. to about 1000° C., and the melting point of a copper substrate may be set to about 1200° C. to about 1400° C. (e.g., the melting point of pure aluminum is about 660° C. and the melting point of pure copper is about 1085° C.). Because the temperature of the heating unit 113 may be adjusted in a subsequent operation, the melting furnace 110 may be provided with a temperature adjustment device for adjusting the temperature of the heating unit 113.

A stirring unit 114 may mix the molded reinforcement body input from the reinforcement body molding machine 100 with the melted substrate material for substantially uniform dispersion.

A discharge unit 115 may discharge the melted substrate material in which the reinforcement body is dispersed, and may include a rotating spiral body (e.g., auger, screw, and/or the like).

In some embodiments, at least two implementation methods may be utilized to input the substrate material and the molded reinforcement body into the melting furnace 110.

The first method is to concurrently (e.g., simultaneously) input both the substrate material and the molded reinforcement body into the melting furnace 110. The substrate material and the molded reinforcement body are concurrently (e.g., simultaneously) put into (or inserted into) the substrate material input unit 111 and the reinforcement body input unit 112 of the melting furnace 110, respectively, and the heating unit 113 of the melting furnace 110 is set to a first temperature (e.g., about 700° C. to about 1000° C. in the case of an aluminum substrate and about 1200° C. to about 1400° C. in the case of a copper substrate). This first temperature may be set to a temperature at which the substrate material is melted but the molded reinforcement body is not melted. This is so that a solid reinforcement body molded into a specific shape may be mixed and dispersed in the melted substrate material. For reference, the melting point of pure aluminum is about 660° C., and the melting point of pure copper is about 1085° C.

The second method is that the substrate material is first put into the substrate material input unit 111 of the melting furnace 110 and melted, and then the molded reinforcement body is put into the reinforcement body input unit 112. In this method, the heating unit 113 of the melting furnace 110 may be first set to the above-described first temperature to melt the substrate material and then the temperature of the heating unit 113 may be adjusted to a second temperature lower than the first temperature (see a temperature setting unit 116 in FIG. 4) to increase the viscosity of the melted substrate material. The molded reinforcement body inputted from the reinforcement body molding machine 100 may then be added to the melting furnace 110 to uniformly (substantially uniformly) disperse the molded reinforcement body in the melted substrate material. The second temperature may be set to a temperature at which the substrate material melted at the first temperature is slightly cooled and the viscosity thereof increases, but is not completely solidified and the molded reinforcement body is not melted. For example, the second temperature may be set to about 600° C. to about 700° C. if (e.g., when) the substrate material is aluminum, and may be set to about 1000° C. to about 1100° C. if (e.g., when) the substrate material is copper.

Returning back to FIG. 2, the melted substrate material produced in the melting furnace 110 and containing the molded reinforcement body may be commercialized into a substrate fabric through subsequent processing equipment, for example, the holding furnace 120, the casting machine 130, the face grinder 140, the uniform heating furnace 150, the hot rolling mill 160, the cold rolling mill 170, and the annealing furnace 180, and may be cut into a desired or required size or shape utilizing the cutter 190.

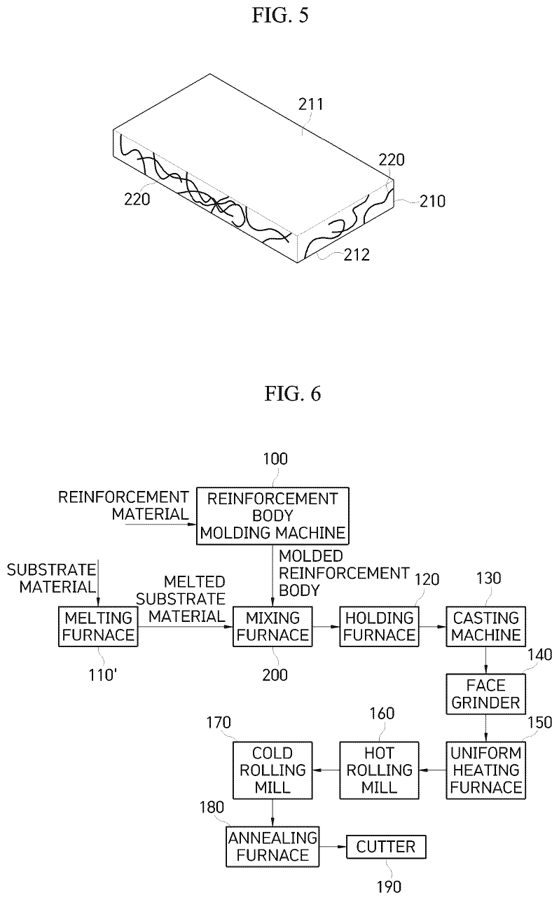

FIG. 5 is a perspective view of an example substrate containing a reinforcement body manufactured by the substrate manufacturing apparatus and method according to one or more embodiments of the present disclosure.

FIG. 5 illustrates that even though a metal substrate 210 contains a reinforcement body 220 and is relatively thin, the strength of the substrate may be reinforced by a reinforcement structure formed by the reinforcement body 220. FIG. 5 further illustrates that both sides of the metal substrate 210, that is, a first side 211 and a second side 212 have been subjected to smooth face grinding together with the reinforcement body 220.

FIG. 6 illustrates one or more other embodiments of an electrode substrate manufacturing apparatus of the present disclosure.

The electrode substrate manufacturing apparatus according to these embodiments may include: the reinforcement body molding machine 100 that molds a reinforcement body from an input reinforcement material; a melting furnace 110′ that melts a substrate material; a mixing furnace 200 that mixes the substrate material melted in the melting furnace 110′ and the molded reinforcement body produced in the reinforcement body molding machine 100 for substantially uniform dispersion; and the holding furnace 120 that performs degassing and component correction on the melted substrate material produced in the mixing furnace 200 and containing the reinforcement body. The manufacturing apparatus or process after the holding furnace 120 may include the casting machine 130, the face grinder 140, the uniform heating furnace 150, the hot rolling mill 160, the cold rolling mill 170, and the annealing furnace 180, and the cutter 190, illustrated in FIG. 2.

In these embodiments, the melting furnace 110′ may melt the substrate material at the above-described first temperature, and the mixing furnace 200 may mix the melted substrate material produced in the melting furnace 110′ and the molded reinforcement body produced in the reinforcement body molding machine 100 at the above-described second temperature for dispersion.

Accordingly, in these embodiments, the melting furnace 110′ may be similar to a configuration in which the reinforcement body input unit 112 and the stirring unit 114 are removed from the melting furnace 110, illustrated in FIG. 4. For example, in these embodiments, the melting furnace 110′ may include the substrate material input unit 111, the heating unit 113, and the discharge unit 115, excluding the reinforcement body input unit 112 and the stirring unit 114, as illustrated in FIG. 4.

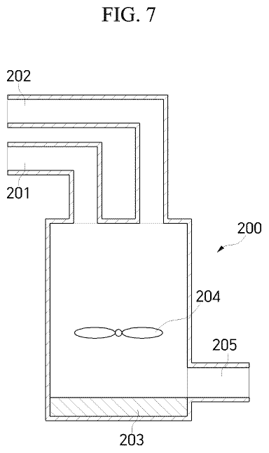

Also, in these embodiments, the mixing furnace 200 may be configured as illustrated in FIG. 7. FIG. 7 is a schematic view illustrating a schematic configuration of the mixing furnace 200 in according to one or more embodiments.

A substrate material input unit 201 receives a substrate material melted in the melting furnace 110′. The substrate material input unit 201 may be connected to the discharge unit (see 115 in FIG. 4) of the melting furnace 110′ so that the melted substrate material may be directly input.

A reinforcement body input unit 202 is an inlet through which the molded reinforcement body molded by and discharged from the reinforcement body molding machine 100 is input, and is configured in an inlet shape in FIG. 7, but the embodiments of the present disclosure are not limited thereto. For example, the reinforcement body input unit 202 may be configured in the form of a hopper. The reinforcement body input unit 202 may be configured to be connected to the discharge unit (103 in FIG. 3) of the reinforcement body molding machine 100 so that the reinforcement body may be continuously input into the melting furnace 110 from the reinforcement body molding machine 100.

A heating unit 203 may increase the viscosity of the melted substrate material as mentioned above at the second temperature lower than the first temperature (e.g., the melting temperature of the substrate material in the melting furnace 110′). The molded reinforcement body input from the reinforcement body molding machine 100 may be mixed in the melted substrate material in this state for substantially uniform dispersion. The second temperature may be set to a temperature at which the substrate material melted at the first temperature is slightly cooled and the viscosity thereof increases, but is not completely solidified and the molded reinforcement body is not melted. For example, the second temperature may be set to about 600° C. to about 700° C. if (e.g., when) the substrate material is aluminum, and may be set to about 1000° C. to about 1100° C. if (e.g., when) the substrate material is copper.

A stirring unit 204 may mix the molded reinforcement body input from the reinforcement body molding machine 100 in the melted substrate material for substantially uniform dispersion.

A discharge unit 205 may discharge the melted substrate material in which the reinforcement body is contained and dispersed.

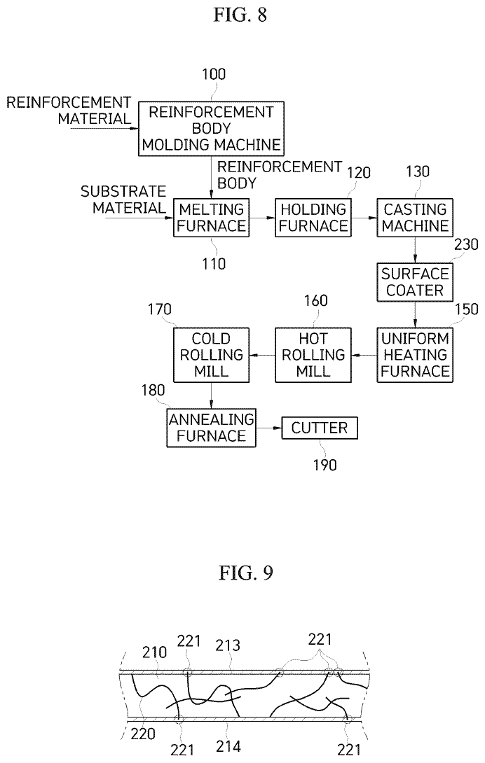

FIG. 8 illustrates one or more other embodiments of an electrode substrate manufacturing apparatus of the present disclosure.

The electrode substrate manufacturing apparatus according to these embodiments perform surface coating by a surface coater 230 instead of or in addition to facing by the face grinder 140 as in the embodiments illustrated in FIGS. 2 and 6.

FIG. 8 illustrates that the face grinder 140 may be omitted and may be replaced with the surface coater 230. However, in other embodiments, the surface coater 230 may be added after the face grinder 140. In other embodiments, the surface coater 230 may be added after the hot rolling mill 160 and the cold rolling mill 170, or may be added after the annealing furnace 180 as a final step or operation.

As illustrated in FIG. 5, even though the first surface 211 and the second surface 212 of the metal substrate 210 are ground and processed smoothly without the protrusion of the reinforcement body 220, if (e.g., when) an electrode plate is manufactured with this electrode substrate later, the reinforcement body 220 may protrude when coating an active material and performing rolling, slitting, notching, and/or the like, which may cause defects such as occurrence of pinholes in the coated layer. Therefore, the surface coater 230 may be utilized to coat both surfaces of the substrate with a metal layer in order to neutralize or reduce the possibility that the reinforcement body will protrude from the surface of the substrate.

In one or more embodiments, the surface coating material is the same material as the substrate or is the same type of the substrate. For example, in the case of an aluminum substrate, an aluminum-based metal layer may be coated, and in the case of a copper substrate, a copper-based metal layer may be coated.

The coating method may utilize electrochemical plating, printing, or vapor deposition.

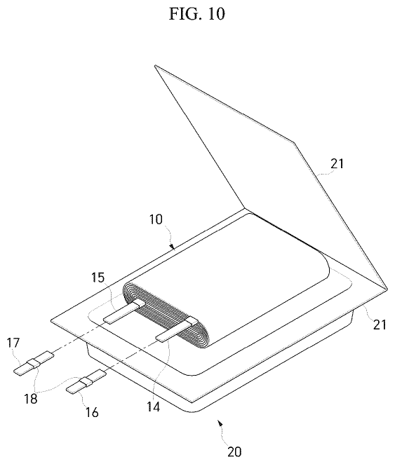

FIG. 9 illustrates a cross sectional view of a metal substrate 210 on which a first side metal layer 213 and a second side metal layer 214 are formed by the surface coater 230.

Even though a portion 221 of the reinforcement body 220 contained inside the metal substrate 210 is exposed to the outside through the surface of the substrate, the reinforcement body 220 may not protrude to the outside by the first side metal layer 213 and the second side metal layer 214. Accordingly, the possibility of defects occurring due to the reinforcement body 220 during active material coating, rolling, slitting, notching, and/or the like, in a subsequent electrode plate manufacturing process may be reduced or avoided.

In some embodiments, the substrate manufacturing method of the present disclosure may be implemented utilizing the electrode substrate manufacturing apparatuses illustrated in FIGS. 2, 6, and 8.

According to one or more embodiments of the present disclosure, by adding a reinforcement body to a substrate material in the manufacturing process of a metal substrate, the strength of the substrate can be reinforced by a reinforcement structure formed by reinforcement bodies even in the case of a thin substrate.

Accordingly, in response to the recent trend of thinning (or reducing) the thickness of an electrode substrate, it is possible to prevent or reduce the likelihood of the substrate from being broken or damaged during coating, rolling, slotting, and notching processes in an electrode plate manufacturing process. Furthermore, the lifespan of manufactured battery products extended.

Hereinafter, any material that may be suitable or usable for the secondary battery according to the one or more embodiments of the present disclosure will be described.

As the positive electrode active material, a compound capable of reversibly intercalating/deintercalating lithium (e.g., a lithiated intercalation compound) may be utilized. For example, at least one of a composite oxide of lithium and a metal such as cobalt, manganese, nickel, or combinations thereof may be utilized.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, and/or any suitable combination thereof.

As an example, a compound represented by any one of the following formulas may be utilized: LiₐA_{1-b}X_{b}O_{2-c}D_{c} (0.90≤a≤1.8, 0≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, and/or any suitable combination thereof; X is Al, Ni, Co, Mn, Cr, Fe, Mg, Sr, V, a rare earth element, and/or any suitable combination thereof; D is O, F, S, P, and/or any suitable combination thereof; G is Al, Cr, Mn, Fe, Mg, La, Ce, Sr, V, and/or any suitable combination thereof; and L1 is Mn, Al, and/or any suitable combination thereof.

A positive electrode for a lithium secondary battery may include a current collector (e.g., a substrate) and a positive electrode active material layer formed on the current collector. The positive electrode active material layer may include a positive electrode active material and may further include a binder and/or a conductive material.

In some examples, the content (e.g., amount) of the positive electrode active material may be in a range of about 90 wt % to about 99.5 wt % on the basis of 100 wt % of the positive electrode active material layer, and the content (e.g., amount) of the binder and the conductive material may be in a range of about 0.5 wt % to about 5 wt %, respectively, on the basis of 100 wt % of the positive electrode active material layer.

The current collector may be aluminum (Al) but the present disclosure is not limited thereto.

The negative electrode active material may include a material capable of reversibly intercalating/deintercalating lithium ions, lithium metal, an alloy of lithium metal, a material capable of being doped and undoped with lithium, a transition metal oxide, and/and/or the like.

The material capable of reversibly intercalating/deintercalating lithium ions may be a carbon-based negative electrode active material, which may include, for example, crystalline carbon, amorphous carbon, and/or any suitable combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and/or the like.

A Si-based negative electrode active material or a Sn-based negative electrode active material may be utilized as the material capable of being doped and undoped with lithium. The Si-based negative electrode active material may be silicon, a silicon-carbon composite, SiOₓ(0<x<2), a Si-based alloy, and/or any suitable combination thereof.

The silicon-carbon composite may be a composite of silicon and amorphous carbon. According to one or more embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer arranged on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, and/or any suitable combination thereof may be utilized as the binder. When an aqueous binder is utilized as the negative electrode binder, a cellulose-based compound capable of imparting viscosity may be further included.

As the negative electrode current collector, one of (e.g., selected from among) copper foil, nickel foil, stainless steel foil, titanium foil, nickel foam, copper foam, conductive metal-coated polymer substrate, and/or combinations thereof may be utilized.

An electrolyte for a lithium secondary battery may include a non-aqueous organic solvent, a lithium salt, and/or the like.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be utilized alone or in combination of two or more.

In one or more embodiments, if (e.g., when) a carbonate-based solvent is utilized, a mixture of cyclic carbonate and chain carbonate may be utilized.

Depending on the type or kind of lithium secondary battery, a separator may be present between the first electrode plate (e.g., the negative electrode) and the second electrode plate (e.g., the positive electrode). The separator may include polyethylene, polypropylene, polyvinylidene fluoride, or a multilayer film of two or more layers thereof.

The separator may include a porous substrate and a coating layer including an organic material, an inorganic material, and/or any suitable combination thereof on one or both surfaces (e.g., opposite surfaces) of the porous substrate.

The organic material may include a polyvinylidene fluoride-based polymer or a (meth)acrylic polymer.

The inorganic material may include inorganic particles of (e.g., selected from among) Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or combinations thereof but the present disclosure is not limited thereto.

The organic material and the inorganic material may be mixed in one coating layer or may be in the form of a coating layer containing an organic material and a coating layer containing an inorganic material that are laminated on each other.

FIG. 10 is a schematic view of a pouch-type secondary battery adopting the electrode substrates manufactured by the method of one or more embodiments of the present disclosure;

The pouch-type secondary battery may include an electrode assembly 10 and a pouch 20 that accommodates the electrode assembly 10.

The electrode assembly 10 is substantially the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with a tab film 18 for insulation from the pouch 20.

The pouch 20 may be sealed by having sealing parts 21 at the edges thereof come into contact with each other with accommodating the electrode assembly 10 therein, in which case the sealing may be achieved with the tab film 18 interposed between the sealing parts 21. The sealing parts 21 of the pouch 20 may each be made of a thermal fusion material that generally has weak adhesion to metal. Thus, it may be fused to the pouch 20 by interposing the thin tab film 18 between the sealing parts 21.

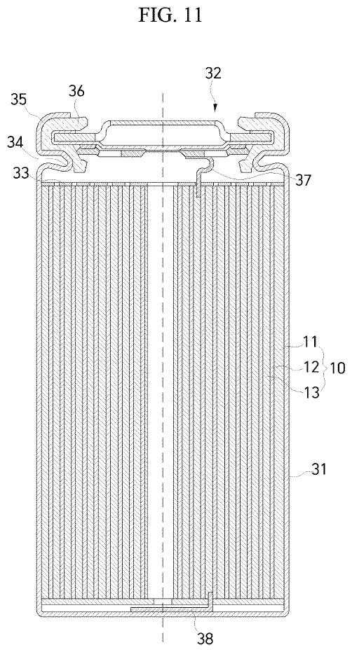

FIG. 11 illustrates a cylindrical secondary battery adopting the electrode substrates manufactured by the method of one or more embodiments of the present disclosure. As shown in FIG. 11, a secondary battery may include an electrode assembly 10, a case 31 accommodating the electrode assembly 10 and an electrolyte therein, a cap assembly 32 coupled to an opening of the case 31 to seal the case 31, and an insulating plate 33 positioned between the electrode assembly 10 and the cap assembly 32 inside the case 31.

The case 31 accommodates the electrode assembly 10 and the electrolyte, and, together with the cap assembly 31, forms the external appearance of the secondary battery. The case 31 may have a substantially cylindrical body portion 12 and a bottom portion connected to one side (e.g., to one end) of the body portion. A beading part 34 (e.g., a bead) deformed inwardly may be formed in the body portion, and a crimping part 35 (e.g., a crimp) bent inwardly may be formed at an open end of the body portion.

The beading part 34 can reduce or prevent movement of the electrode assembly 10 inside the case 31 and can facilitate seating of the gasket and the cap assembly 31. The crimping part 35 may firmly fix the cap assembly 32 by pressing the edge of the case 31 against the gasket 36. The case 31 may be formed of iron plated with nickel, for example.

The cap assembly 32 may be fixed to the inside of the crimping part 35 by a gasket 36 to seal the case 31. A first lead tab 37 drawn out from the electrode assembly 10 may be connected to the cap assembly 32, and a second lead tab 38 drawn out from the electrode assembly 10 may be electrically connected to the bottom of the casing 31.

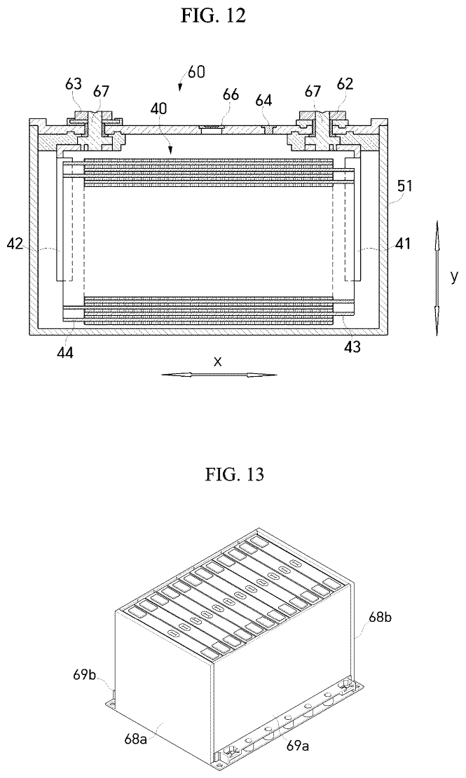

FIG. 12 shows the internal structure of the prismatic secondary battery adopting the electrode substrates manufactured by the method of one or more embodiments of the present disclosure.

As shown in FIG. 12, a prismatic secondary battery may include an electrode assembly 40, a first current collector 41, a first terminal 62, a second current collector 42, a second terminal 63, a case 51, and a cap assembly 60.

An electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction (e.g., the x direction) of the case 51. In other embodiments, the electrode assembly 40 may be a stack type rather than a winding type, and the shape of the electrode assembly 40 is not limited to those specifically described in the present disclosure. In one or more embodiments, the electrode assembly 40 may be a Z-stack electrode assembly in which a positive electrode plate and a negative electrode plate are inserted into both sides of a separator, which is then bent into a Z-stack. In one or more embodiments, one or more electrode assemblies may be stacked such that long sides of the electrode assemblies are adjacent to each other and accommodated in the case, and the number of electrode assemblies in the case is not limited by the present disclosure. The first electrode plate of the electrode assembly may act as a negative electrode, and the second electrode plate may act as a positive electrode, and vice versa.

In the electrode assembly 40, the first current collector 41 and the second current collector 42 may be welded and connected to the first electrode tab 43 extending from the first electrode plate and the second electrode tab 44 extending from the second electrode plate, respectively. In some embodiments in which the first electrode tab 43 and the second electrode tab 44 are located at the top of the electrode assembly 40, the first and second current collectors are located at the top of the electrode assembly 40.

As illustrated in FIG. 12, the first current collector 41 and the second current collector 42 are connected to the first terminal 62 and the second terminal 63 through connection members 67, respectively. In some embodiments, the connection members 67 may each have an outer peripheral surface that is threaded, and may be fastened to the first terminal 62 and the second terminal 63 by screwing. However, the present disclosure is not limited thereto. For example, the connection members 67 may also be coupled to the first terminal 62 and the second terminal 63 by riveting or welding.

FIG. 13 is a view of a secondary battery module in which prismatic secondary batteries are arranged according to some embodiments of the present disclosure. With the increase in secondary battery capacity for driving electric vehicles and/or the like, a secondary battery module may be manufactured by arranging and connecting a plurality of secondary battery cells transversely and/or longitudinally. The plurality of secondary batteries may be arranged in a space defined by a pair of facing end plates 68a and 68b and a pair of facing side plates 69a and 69b. The secondary batteries may be designed appropriately in a suitable arrangement (e.g., direction) and number to obtain desired or suitable voltage and current capabilities.

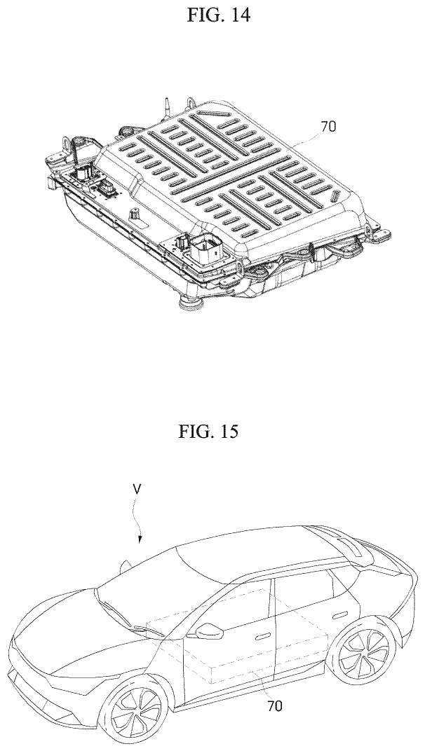

FIG. 14 is a view schematically showing the configuration of a battery pack 70 according to some embodiments of the present disclosure. Referring to FIG. 14, a battery pack 70 may include an assembly to which individual batteries are electrically connected and a pack housing accommodating the same. In the drawings, for convenience of illustration, components including a bus bar, a cooling unit, external terminals for electrically connecting batteries, and/or the like, are not shown.

The battery pack 70 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle, but the present disclosure is not limited thereto. FIG. 15 shows a vehicle V which includes the battery pack 70 shown in FIG. 14 on the lower portion of the body thereof. The vehicle V may operate by (e.g., may be powered by) receiving power from the battery pack 70.

Although the present disclosure has been described above with respect to some embodiments thereof, the present disclosure is not limited thereto. Various suitable modifications and variations may be made thereto by those skilled in the art within the spirit of the present disclosure, the scope of which is defined by the following claims and their equivalents thereof.

What is claimed is:

1. An apparatus for manufacturing an electrode substrate of a secondary battery, the apparatus comprising:
a reinforcement body molding machine configured to mold a reinforcement body from a reinforcement material;
a melting furnace configured to melt a substrate material and mix the molded reinforcement body in the melted substrate material for dispersion;
a casting machine containing the reinforcement body configured to mold a slab with the melted substrate material produced by the melting furnace; and
a rolling mill configured to form an electrode substrate by rolling the slab.

2. The apparatus as claimed in claim 1, wherein the reinforcement material inputted into the reinforcement body molding machine comprises a conductive material with greater strength than the substrate material.

3. The apparatus as claimed in claim 2, wherein the reinforcement material is one or more materials selected from: tungsten carbide, a carbide-based metal, cobalt, titanium, nickel, iron, carbon steel, alloy steel, heat-treated steel, or carbon fiber.

4. The apparatus as claimed in claim 1, wherein a shape of the reinforcement body molded by the reinforcement body molding machine is one or more shapes selected from: a plate shape, a needle shape, a fiber shape, or a linear shape.

5. The apparatus as claimed in claim 1, wherein the melting furnace comprises:
a substrate material input unit;
a reinforcement body input unit configured to input the reinforcement body molded by the reinforcement body molding machine;
a heating unit configured to generate heat for melting the input substrate material; and
a stirring unit configured to mix the reinforcement body molded by the reinforcement body molding machine in the melted substrate material for dispersion.

6. The apparatus as claimed in claim 1, wherein the melting furnace is further configured to melt the substrate material by heating the substrate material and the molded reinforcement body at a first temperature, and
the first temperature is set to a temperature at which the substrate material melts and the molded reinforcement body does not melt.

7. The apparatus as claimed in claim 1, wherein the melting furnace is further configured to melt the substrate material at a first temperature, and receive the molded reinforcement body responsive to the first temperature being adjusted to a second temperature,
the first temperature is set to a temperature at which the substrate material melts and the molded reinforcement body does not melted, and
the second temperature is set to a temperature lower than the first temperature.

8. The apparatus as claimed in claim 1, further comprising:
a surface coater configured to coat a metal layer on a surface of the formed electrode substrate.

9. A method for manufacturing an electrode substrate of a secondary battery, the method comprising:
molding a reinforcement body from a reinforcement material;
melting a substrate material and mixing the molded reinforcement body in the melted substrate material for dispersion;
molding a slab with the melted substrate material comprising the molded reinforcement body; and
forming an electrode substrate by rolling the slab.

10. The method as claimed in claim 9, wherein the reinforcement material for molding the reinforcement body comprises a conductive material having a greater strength than the substrate material.

11. The method as claimed in claim 10, wherein the reinforcement material is one or more materials selected from: tungsten carbide, a carbide-based metal, cobalt, titanium, nickel, iron, carbon steel, alloy steel, heat-treated steel, or carbon fiber.

12. The method as claimed in claim 9, wherein a shape of the reinforcement body molded in the molding the reinforcement body is one or more shapes selected from: a plate shape, a needle shape, a fiber shape, or a linear shape.

13. The method as claimed in claim 9, wherein the melting the substrate material and mixing the molded reinforcement body in the melted substrate material for dispersion comprises:
melting the substrate material by heating the substrate material and the molded reinforcement body at a first temperature, and
wherein the first temperature is set to a temperature at which the substrate material melts and the molded reinforcement body does not melt.

14. The method as claimed in claim 9, wherein the melting the substrate material and mixing the molded reinforcement body in the melted substrate material for dispersion comprises:
melting the substrate material at a first temperature,
adjusting the first temperature to a second temperature, and
receiving the molded reinforcement body after adjusting the first temperature,
wherein the first temperature is set to a temperature at which the substrate material melts and the molded reinforcement body does not melt, and
the second temperature is lower than the first temperature.

15. The method as claimed in claim 9, further comprising:
coating a metal layer at a surface of the formed electrode substrate.

16. An electrode substrate of a secondary battery manufactured by a method for manufacturing a secondary battery electrode substrate, the method comprising:
molding a reinforcement body from a reinforcement material;
melting a substrate material and mixing the molded reinforcement body in the melted substrate material for dispersion;
molding a slab using the melted substrate material containing the molded reinforcement body; and
forming a substrate by rolling the slab.

17. The electrode substrate of a secondary battery as claimed in claim 16, wherein the reinforcement material comprises a conductive material with greater strength than the substrate material.

18. The electrode substrate of a secondary battery as claimed in claim 16, wherein the reinforcement material comprises one or more materials selected from: tungsten carbide, a carbide-based metal, cobalt, titanium, nickel, iron, carbon steel, alloy steel, heat-treated steel, or carbon fiber.

19. The electrode substrate of a secondary battery as claimed in claim 16, wherein a shape of the reinforcement body molded is one or more shapes selected from a plate shape, a needle shape, a fiber shape, or a linear shape.

20. The electrode substrate of a secondary battery as claimed in claim 16, wherein the method further comprises:
coating a metal layer at a surface of the formed substrate.
